(19) United States
(12) Patent Application Publication
(10) Pub. No.: US 2010/0311020 A1
(43) Pub. Date: Dec. 9, 2010

(54) TEACHING MATERIAL AUTO EXPANDING METHOD AND LEARNING MATERIAL EXPANDING SYSTEM USING THE SAME, AND MACHINE READABLE MEDIUM THEREOF

(75) Inventors: Min-Hsin Shen, Taichung City (TW); Ching-Hsien Li, Kaohsiung City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/544,918

(22) Filed: Aug. 20, 2009

(30) Foreign Application Priority Data
Jun. 8, 2009 (TW) TW98118998

(51) Int. Cl. G09B 19/06; G09B 7/00

(52) U.S. Cl. 434/157; 434/167; 434/169

(57) ABSTRACT

A teaching material auto expanding method for expending an input teaching material data having at least one sentence unit into a database in a learning material expanding system is disclosed. The database has multiple subjects and structure information corresponding thereto, each subject having a corresponding subject category and each subject category having at least one corresponding sentence unit. First, subject similarity values corresponding to each subject in the database for each of the sentence units in the input teaching material data are separately calculated wherein each subject similarity value comprises a content similarity value and a structure similarity value. A confidence measurement operation is then performed to obtain confidence measurement values of each of the subjects by using the subject similarity value for each sentence unit. Thereafter, an expanding manner for each sentence unit is determined based on the obtained confidence measurement value corresponding thereto.

### CROSS REFERENCE TO RELATED APPLICATIONS

This Application claims priority of Taiwan Patent Application No. 098118998, filed on Jun. 8, 2009, the entirety of which is incorporated by reference herein

### BACKGROUND OF THE INVENTION

1. Field of the Invention

The disclosure relates generally to teaching material auto expanding method and learning material expanding system using the same, and machine readable medium.

2. Description of the Related Art

In recent years, with the vigorous growth of digital learning, more and more variety teaching materials, such as language teaching materials, have been provided to users for practice to assist them in language learning. In the language learning, simple listening comprehension and speaking drills practices have been moved into an interactive conversation that simulates the live conversations. However, to meet the real live environment, a learning system (e.g. a real situation simulation conversation learning system) must have a set of rich situation simulation teaching materials.

The rich situation simulation teaching materials must consist of multi-path conversation teaching materials. Such multi-path conversation teaching materials require be editing and arranging manually by human power in advance and expanding of the teaching materials also consumes huge human power in process of separating and classifying the teaching materials, making the expanding of the teaching materials become difficult.

### SUMMARY

It is therefore an objective to provide a teaching material auto expanding method for a learning material expanding system to speedily and automatically expand content of a new teaching material into original database so as to efficiently simulate the real life situations.

In one exemplary embodiment, a teaching material auto expanding method for expending an input teaching material data comprising at least one sentence unit into a database in a learning material expanding system is provided, wherein the database has at least one subject and a structure information corresponding thereto, each subject having a corresponding subject category and each subject category having at least one corresponding subject sentence unit. The method comprises calculating a subject similarity value corresponding to the subject in the database for the sentence unit in the input teaching material data, wherein the subject similarity value comprises a content similarity value and a structure similarity value corresponding to the subject; performing a confidence measurement operation to obtain a confidence measurement value of the subject by using the subject similarity value for the sentence unit; and determining an expanding manner for the sentence unit based on the obtained confidence measurement value corresponding thereto.

An exemplary embodiment of a learning material expanding system comprises a database, a content similarity calculation module, a structure similarity calculation module, a subject similarity calculation module, a confidence calculation module and an auto expanding module. The database has a plurality of subjects and at least one structure information corresponding thereto, wherein each of the subjects has a corresponding subject category and each subject category has at least one corresponding subject sentence unit. The content similarity calculation module is coupled to the database for receiving an input teaching material data comprising a plurality of sentence units and calculating subject similarity values corresponding to all of the subjects in the database, each of which corresponding to one of the subjects, for each of the sentence units in the input teaching material data, wherein the sentence units of the input teaching material data has a flow structure information. The structure similarity calculation module is coupled to the content similarity calculation module for utilizing the flow structure information and the structure information of the database to obtain structure similarity values corresponding to the subjects, each of which corresponding to one of the subjects, for each of the sentence units. The subject similarity calculation module is coupled to the content similarity calculation module and the structure similarity calculation module for obtaining subject similarity values corresponding to the subjects, each of which corresponding to one of the subjects, according to the corresponding content similarity value and the corresponding structure similarity value of each of the subjects for each of the sentence units. The confidence calculation module is coupled to the subject similarity calculation module for performing a confidence measurement operation to obtain a confidence measurement value of each of the subjects by using the subject similarity value of each of the subjects for each of the sentence units. The auto expanding module is coupled to the confidence calculation module for determining an expanding manner for each of the sentence units based on the obtained confidence measurement value corresponding thereto so as to adding the input teaching material data into the database.

Teaching material auto expanding method and learning material expanding system using the same may take the form of a program code embodied in a tangible media. When the program code is loaded into and executed by a machine, the machine becomes an apparatus for practicing the disclosed method.

### BRIEF DESCRIPTION OF THE DRAWINGS

The disclosure will become more fully understood by referring to the following detailed description with reference to the accompanying drawings, wherein:

FIG. 1 is a schematic diagram illustrating an exemplary embodiment of a learning material expanding system of the invention;

FIG. 2 is a schematic diagram illustrating an exemplary embodiment of a subject flow structure of the invention;

FIG. 3 is a schematic diagram illustrating an exemplary embodiment of a process flow for calculating the semantic similarity;

FIG. 4 is a flowchart of an exemplary embodiment of a teaching material auto expanding method; and

FIG. 5 is a flowchart of another exemplary embodiment of a teaching material auto expanding method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

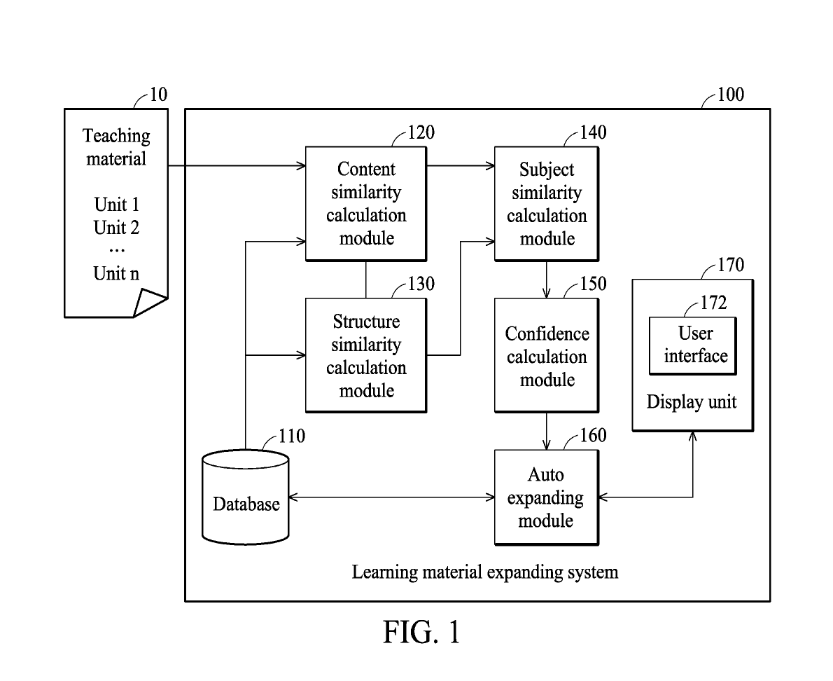

FIG. 1 is a schematic diagram illustrating an exemplary embodiment of a learning material expanding system 100 of the invention. In one exemplary embodiment, the learning material expanding system 100 may be a language learning material expanding system. As shown in FIG. 1, the learning material expanding system 100 at least comprises a database 110, a content similarity calculation module 120, a structure similarity calculation module 130, a subject similarity calculation module 140, a confidence calculation module 150, an auto expanding module 160 and a display unit 170. The database 110, for example, may comprise multiple subjects and a structure information corresponding to the subjects, wherein each subject has a corresponding subject category (also referred to as sentence category) and each subject category has at least one sentence unit (e.g. a conversation sentence), a subject topic and a role played. Each subject category may comprise a group of subject sentence units that with the same subject and the subject structure information identifies flow structure information between the subjects.

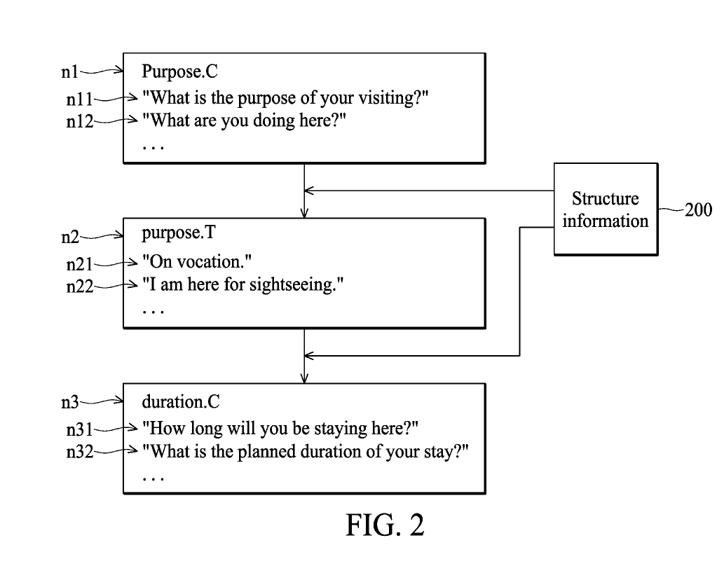

FIG. 2 is a schematic diagram illustrating an exemplary embodiment of a subject flow structure of the invention. In FIG. 2, subject categories n1, n2, n3 and structure information 200 corresponding thereto are illustrated. The subject category nil has a subject “purpose.C” and corresponsive subject sentence units n11 and n12, the subject category n2 has a subject “purpose.T” and corresponsive subject sentence units n21 and n22 and the subject category n3 has a subject “duration.C” and corresponsive subject sentence units n31 and n32. The structure information 200 records information regarding specific corresponsive relationship between the subject categories, i.e. the flow structure of the subjects, n1−>n2−>n3. The structure similarity calculation module 130 may then utilize this flow structure information 200 to calculate and obtain a corresponding structure similarity value of each of the sentence units within an input teaching material data.

The content similarity calculation module 120 is coupled to the database 110 and the content similarity calculation module 120 receives an input teaching material data 10 comprising multiple sentence units, obtains a semantic similarity comparison result by comparing each sentence unit of the input teaching material data with each subject sentence unit of each subject category within the database, obtains a content similarity value corresponding to each of the subject categories within the database for each sentence unit of the input teaching material data, and selects at least one candidate subject based on the semantic similarity comparison result. In this embodiment, the input teaching material data 10 comprises unit 1 to unit n. For example, each sentence unit may be a conversation sentence if the input teaching material data is a conversation teaching material data.

The structure similarity calculation module 130 may obtain a corresponding structure similarity value by using the subject structure information within in the database and a corresponding relationship between candidate subjects that correspond to all of the sentence units of the input teaching material data 10, each sentence unit having a corresponding candidate subject. The subject similarity calculation module 140 is coupled to the content similarity calculation module 120 and the structure similarity calculation module 130 for obtaining a subject similarity value corresponding to each subject according to the content similarity values calculated by the content similarity calculation module 120 and the structure similarity values calculated by the structure similarity calculation module 130. The confidence calculation module 150 is coupled to the subject similarity calculation module 140 for performing a confidence measurement operation to obtain a confidence measurement value of each subject using the subject similarity value of each subject calculated by the subject similarity calculation module 140. The confidence calculation module 150 may utilize predefined reject threshold and accept threshold to obtain the confidence measurement values.

The auto expanding module 160 is coupled to the confidence calculation module 150 and the sentence display unit 170 for determining an expanding manner for each sentence unit based on the obtained confidence measurement value corresponding thereto. The expanding manner may comprise, for example, adding a new subject category, automatically merging into one of the original subject categories, and automatically displaying candidate subjects ordered by the corresponding subject similarity values in sequence, but the invention is not limited thereto. When a corresponding confidence measurement value of a sentence unit is less than the reject threshold, the auto expanding module 160 may automatically generate a new subject category. Otherwise, the auto expanding module 160 may further inspect that whether the corresponding confidence measurement value of the sentence unit exceeds the accept threshold or not. If so, the auto expanding module 160 may automatically merge the sentence unit into one of the original subject categories; and if not, the auto expanding module 160 may display candidate subjects ordered by the corresponding subject similarity values in sequence and provide a recommended subject by the sentence display unit 170. The sentence display unit 170 may further provide a user interface 172 such that a user may edit or modify the corresponding relationship therethrough according to the confidence measurement values and similarity values.

When a new teaching material that has more than one sentence unit has been inputted, a content similarity value of each sentence unit within the new teaching material for each subject within the database may be obtained by the content similarity calculation module 120, and then flow structure between the sentence units within the new teaching material is analyzed by the structure similarity module 130 to obtain a structure similarity value. Thereafter, subject similarity values of each sentence unit for each candidate subject that corresponds to the sentence unit can be obtained by the subject similarity module 140 by combining both the content similarity values and the structure similarity values obtained.

Next, the confidence calculation module 150 performs a confidence measurement operation to obtain a confidence measurement value of each subject, and finally, the auto expanding module 160 may determine an expanding manner for each new unit according to the confidence measurement value of each subject.

An exemplary embodiment is used below to explain the detailed process of a teaching material auto expanding method of the invention.

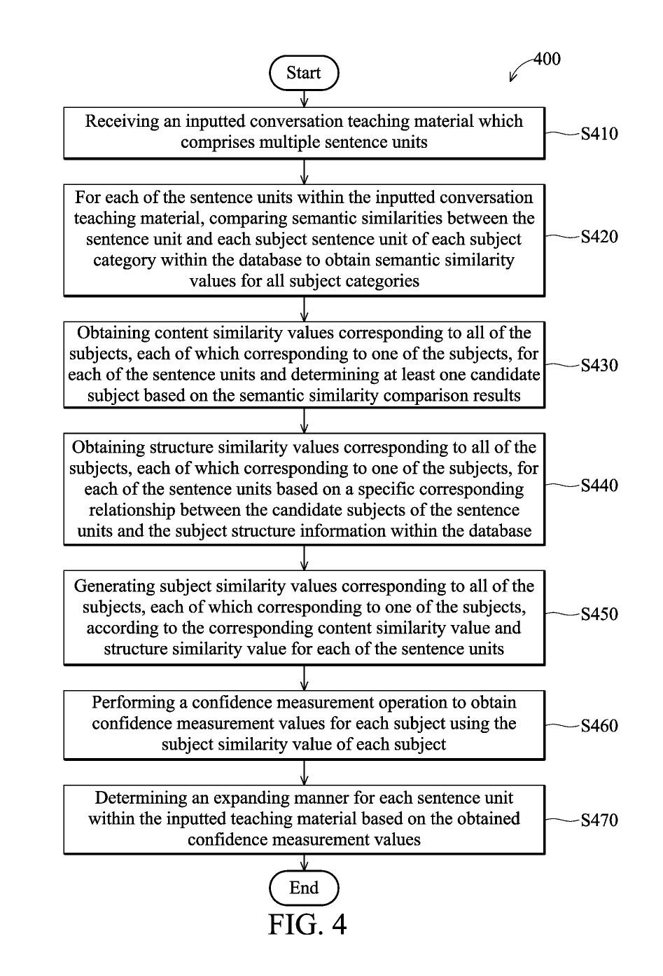

FIG. 4 is a flowchart 400 of an exemplary embodiment of a teaching material auto expanding method of the disclosure. The teaching material auto expanding method of the disclosure can be executed by the learning material expanding system 100 shown in FIG. 1. It is to be noted that, for explanation, a language learning material expanding system is configured as the learning material expanding system 100 and a conversation teaching material comprises multiple sentence units is used as the inputted teaching material data 10 in the following embodiments, but the invention is not limited thereto.

First, when a new conversation teaching material 10 has been inputted, in step S410, the content similarity calculation module 120 receives the inputted conversation teaching material 10 in which the inputted conversation teaching material 10 comprises multiple sentence units S1˜Sn.

Next, in step S420, the content similarity calculation module 120 compares, for each of the sentence units within the inputted conversation teaching material 10, semantic similarities between the sentence unit and each subject sentence unit of each subject category within the database 110 to obtain semantic similarity values for all subject categories.

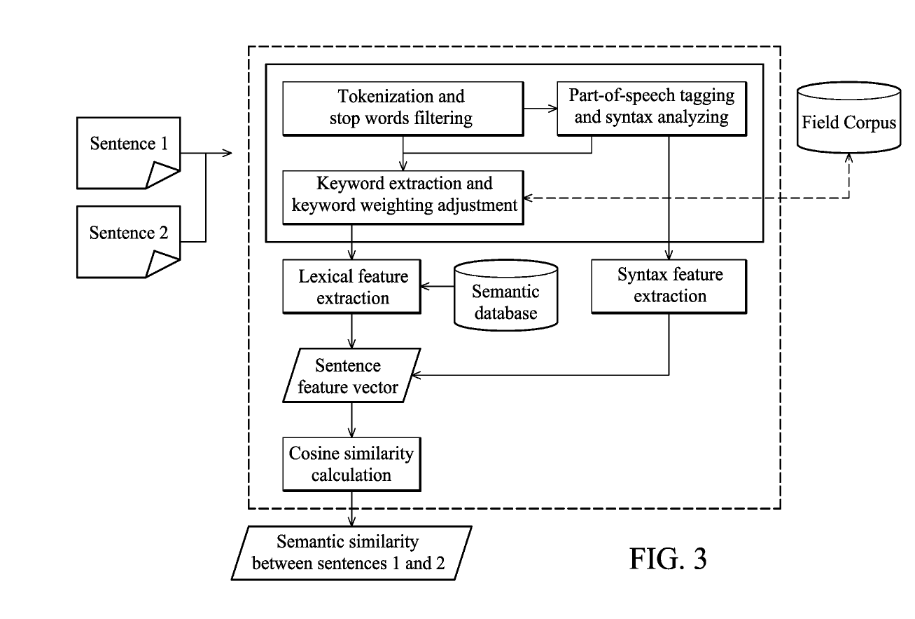

In one exemplary embodiment, the semantic similarity values may be calculated by the method described below. It is assumed that the new teaching material 10 has n sentence units and the database 110 stores m predefined subject categories. In this case, the content similarity calculation module 120 may perform a semantic similarity calculation method shown in FIG. 3 to obtain a semantic similarity value between two sentences.

FIG. 3 is a schematic diagram illustrating an exemplary embodiment of a process flow for calculating the semantic similarity. As shown in FIG. 3, the semantic similarity calculation between two sentences may at least comprise a tokenization, a stop words filtering, a part-of-speech tagging, a keyword extraction and a keyword weighting adjustment steps or modules. For example, in one exemplary embodiment, two sentence units may first perform a tokenization step by a tokenization module for tokenization, then perform a stop words filtering step by a stop words filtering module to obtain lexical features and may further perform a keyword extraction and keyword weighting adjustment steps by suitable modules to adjust and modify the obtained lexical feature values, wherein the feature values may be obtained by utilizing the lexical and/or semantic similarity of the field corpus or the semantic database. The obtained lexical feature values may be further performed a part-of-speech tagging and syntax analysis step by a part-of-speech tagging and syntax analysis module to obtain the syntax features of the sentences and obtains feature vectors of the two sentences respectively. Thereafter, the semantic similarity value between two sentences may be calculated by a cosine similarity calculation. It is understood that steps of the tokenization, the stop words filtering, the part-of-speech tagging, the keyword extraction, the keyword weighting adjustment and/or the use of the corpus are well known in the art, and thus detailed description are omitted here.

After obtaining semantic similarity values of each sentence unit, in step S430, the content similarity module 120 may obtain content similarity values corresponding to all of the subjects, each of which corresponding to one of the subjects, for each of the sentence units and determine at least one candidate subject based on the semantic similarity comparison results. Note that a content similarity value of a selected subject is configured as a subject which has the maximum semantic similarity value among the semantic similarity values corresponding to the selected subject. Therefore, each sentence unit may obtain a candidate subject according to the content similarity values corresponding thereto. In one embodiment, the content similarity calculation module 120 may configure the subject which has the maximum semantic similarity value among the semantic similarity values as the candidate subject. For example, if the subjects (or subject categories) x and y respectively comprise sentence x1, x2, x3 and y1, y2, and the semantic similarity values corresponding thereto are 0.88, 0.87, 0.90 and 0.81, 0.76 respectively, the content similarity values for the subjects x and y are set to the corresponding maximum one of its semantic similarity values, 0.90 and 0.81, wherein the subject x is therefore configured as the candidate subject.

After the content similarity values corresponding to all of the subjects, each of which corresponding to one of the subjects, for each of the sentence units have been obtained, in step S440, the structure similarity module 130 may obtain structure similarity values corresponding to all of the subjects, each of which corresponding to one of the subjects, for each of the sentence units based on a specific corresponding relationship between the candidate subjects of the sentence units and the subject structure information within the database.

For example, in one exemplary embodiment, the content similarity values may be calculated by the method described below. It is assumed that the corresponding candidate subjects x, y, z of the sentences have following corresponding relationship:

x−>y−>z (1),

and, the subjects n1, n2, n3 within the database 110 have the following structure information 200 (referring to FIG. 2):

n1−>n2−>n3 (2).

Obviously, if the candidate subject x corresponds to the subject n1 and the candidate subject z corresponds to the subject n3, according to the formulas (1) and (2), the similarity value for that the candidate subject y corresponds to the subject n2 should be given a higher value than others. Therefore, structure similarity values corresponding to all of the subjects may be obtained based on a corresponding relationship between each flow of the sentence units. In one embodiment, the structure similarity value σ_{flow}(nᵢⱼ) corresponding to the subjects may be calculated by following formulas:

G_{T}= [symbol] N_{T},E_{T} [symbol] ; New material:G_{S}= [symbol] N_{S},E_{S} [symbol] ;

N={nᵢ|nᵢ is a sentence category, nᵢ contains at least one sentence}

E={nᵢnⱼ|nᵢ,nⱼεN}, path n̅ᵢ̅n̅ₖ̅ represents nᵢ . . . nₖ . . . nⱼ

σᵢₙ(nᵢⱼ)=max(σ(n_{xy})), where nᵢ,nₓεN_{S},nⱼ,n_{y}εN_{T}, and ∃ n̅ₓ̅n̅ᵢ̅ in G_{S}

σₒᵤₜ(nᵢⱼ)=max(σ(n_{xy})), where nᵢ,nₓεN_{S},nⱼ,n_{y}εN_{T}, and ∃ n̅ᵢ̅n̅ₓ̅ in G_{S}

σ_{flow}(nᵢⱼ)=avg(σᵢₙ(nᵢⱼ),σₒᵤₜ(nᵢⱼ)),

where G_{T} represents the graphic structure included in the database, G_{S} represents the graphic structure included in the inputted sentences, N represents nodes of the graphic, E represents the edge boundary of the graphic, σᵢₙ(nᵢⱼ) represents the highest similarity value before comparing with the nodes, σₒᵤₜ(nᵢⱼ) represents the highest similarity value after the nodes have been compared and σ_{flow}(nᵢⱼ) represents the structure similarity value.

After the structure similarity values have been obtained, in step S450, the subject similarity module 140 may generate subject similarity values corresponding to all of the subjects, each of which corresponding to one of the subjects, according to the corresponding content similarity value and structure similarity value of each sentence unit within the inputted teaching material. Note that the content similarity value and the structure similarity value are with a weighting relation that represents the ratio of the content similarity value and the structure similarity value occupied in a generated subject similarity value. For example, if the content similarity value is with a weighting of 0.6, the structure similarity value is with a weighting of 1−0.6=0.4, which represents that the calculation of the subject similarity value for each subject is mainly most considering the content similarity. Similarly, if the content similarity value is with a weighting of 0.4, the structure similarity value is with a weighting of 1−0.4=0.6, which represents that the calculation of the subject similarity value for each subject is mainly most considering the structure similarity. In one embodiment, the subject similarity value of the i^{th} sentence within the teaching material for the j^{th} subject category within the database can be calculated by following formula:

σ(nᵢⱼ)=Wᵤₙᵢ×σᵤₙᵢ(nᵢⱼ)+(1−Wᵤₙᵢ)×σ_{flow}(nᵢⱼ),

wherein σᵤₙᵢ(nᵢⱼ) represents the content similarity value of the i^{th} sentence for the j^{th} subject category, σ_{flow}(nᵢⱼ) represents the structure similarity value of the i^{th} sentence for the j^{th} subject category and Wᵤₙᵢ represents a weighting assigned.

After all of the subject similarity values of all candidate subjects corresponding to all sentences haven been obtained, in step S460, the confidence calculation module 150 performs a confidence measurement operation to obtain a confidence measurement value for each subject using the subject similarity value for each subject. Thereafter, in step S470, the auto expanding module 160 determines an expanding manner for each sentence unit within the inputted teaching material based on the obtained confidence measurement value corresponding thereto. The expanding manner may comprise, for example, adding a new subject category, automatically merging into one of the original subject categories, and automatically displaying and recommending candidate subjects ordered by the corresponding subject similarity values in sequence, but the invention is not limited thereto.

In this exemplary embodiment, calculation of the confidence measurement may comprise a calculation of an out of domain confidence measurement CM_{OOD} and a calculation of a topic confidence measurement CM_{topic}. The out of domain confidence measurement CM_{OOD} may be determined by using a reject threshold TH_{R} to determine whether the inputted teaching material belongs to one of the original subject categories while the topic confidence measurement CM_{topic} may be determined by using an accept threshold TH_{A} to determine the difference between similarities of each of the candidate subjects, wherein the values of the reject threshold TH_{R} and the accept threshold TH_{A} can be determined and adjusted according to the content of the teaching material and the experience in practice.

The out of domain confidence measurement CM_{OOD} can be calculated by following formula:

$$V 1 ( {n}_{i} ) = \{ \begin{matrix}1 , & when C {M}_{OOD} ( {n}_{i} ) \geq {TH}_{R} \\ 0 , & otherwise\end{matrix} \\ C {M}_{OOD} ( {n}_{i} ) = {\sum }_{k = 1 … m} {λ}_{k} {σ}_{( {n}_{ik} )} ,$$

wherein nᵢ represents the i^{th} subject category, λₖ represents a predefined weighting of the subject category nₖ and V1(nᵢ) represents a determination function of the out of domain confidence measurement. From the determination function V1(nᵢ), the value of the V1(nᵢ) is set to be 0 when the out of domain confidence measurement CM_{OOD} is less than the reject threshold TH_{R}, which indicates that a new subject category has to be added since the new teaching material is not belong to any of the original subject categories. Further, when the out of domain confidence measurement CM_{OOD} is equal to or exceeds the reject threshold TH_{R}, the value of the V1(nᵢ) is set to be 1 and the topic confidence measurement CM_{topic} is further calculated.

Similarly, the topic confidence measurement CM_{topic} can be calculated by following formula:

$$C {M}_{topic} ( {n}_{i} ) = \frac{σ ( {n}_{ij} )}{σ ( {n}_{il} )} , \\ l = arg {max}_{k = 1 … m , k \neq j} σ ( {n}_{ik} )$$

$$V 2 ( {n}_{i} ) = \{ \begin{matrix}1 , & when C {M}_{topic} ( {n}_{i} ) \geq {TH}_{A} \\ 0 , & otherwise ,\end{matrix}$$

wherein σ(nᵢⱼ) represents the subject similarity value of the subject category j that is the most possible corresponding one for the i^{th} sentence in the new teaching material, σ(nᵢₗ) represents the subject similarity value of the subject category 1 that is the secondary possible corresponding one for the i^{th} sentence and V2(nᵢ) represents a determination function of the topic confidence measurement. In other words, the topic confidence measurement can be used to determine the difference between similarities of each of the candidate subjects. From the determination function V2(nᵢ), the value of the V2(nᵢ) is set to be 1 when the topic confidence measurement CM_{topic} exceeds or equals to the accept threshold TH_{A}, which indicates that the subject category that the i^{th} sentence in the new teaching material most similar to is the subject category j so that the i^{th} sentence of the new teaching material is automatically merged into the subject category j. Otherwise, i.e. the value of the V2(nᵢ) is set to be 0, it indicates that more than one subject category may similar to the i^{th} sentence in the new teaching material, e.g. both the subject categories i and 1 are similar to the i^{th} sentence, so the candidate subjects may be ordered and displayed by the corresponding subject similarity values in sequence automatically.

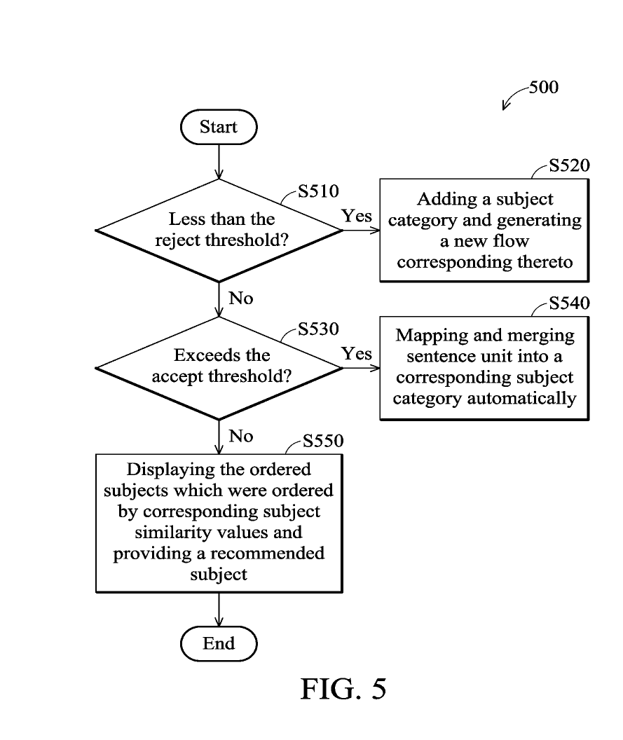

FIG. 5 is a flowchart 500 of another exemplary embodiment of a teaching material auto expanding method of the invention. As shown in FIG. 5, in step S510, the confidence calculation module 150 first calculates the out of domain confidence measurement CM_{OOD} to determine whether a corresponding subject similarity value, corresponding to each subject, of each of the sentences within the inputted teaching material is less than a reject threshold TH_{R}. If the corresponding subject similarity value of one of the sentences is less than the reject threshold TH_{R} (Yes in step S510), it indicates that this sentence is dissimilar to any of the subjects within current database, i.e. it is a new subject, and thus, in step S520, the auto expanding module 160 may determine the expanding manner as to add a subject and a corresponding subject category and then further configure the sentence as a unit of the newly added subject category. If the corresponding subject similarity value of this sentence equals to or exceeds the reject threshold TH_{R} (No in step S510), in step S530, the confidence calculation module 150 may further calculate the topic confidence measurement CM_{topic} to determine whether the corresponding subject similarity value of said sentence exceeds the accept threshold TH_{A}. If the corresponding subject similarity value of said sentence unit exceeds the accept threshold TH_{A} (Yes in step S530), in step S540, it indicates that this sentence unit is most similar to the subject category that corresponds to the subject similarity value and thus the confidence calculation module 150 may automatically map and merge the sentence unit into the subject category that it most similar to.

If the corresponding subject similarity value of said sentence unit is less than or equal to the accept threshold TH_{A} (No in step S530), it indicates that more than one possible candidate subject categories are presented in the database, and thus, in step S550, the auto expanding module 160 may sort all of the subjects by the corresponding similarity values and then display the ordered subjects and provide a recommended subject on the sentence display unit 170. For example, the auto expanding module 160 may display an ordered subject list with all of the subjects from large to small in sequence in responsive to the subject similarity values corresponding thereto and display a recommended subject. Users may directly merge the new sentence into the recommended subject category or manually determine which subject category is to be merged for the new sentence within the new teaching material via the user interface 172.

In summary, according to the learning material expanding system and the teaching material auto expanding method using the same of the invention, difference between new sentence units of a newly added teaching material and sentence units within the original database can be compared and analyzed, and a mapping relationship thereof can be established so that the new sentence units can be automatically expanded to the database. Furthermore, by the confidence measurement, the established mapping relationship can be modified to eliminate the need for human power interfered for manually expanding the teaching material so as to achieve a goal for speedily auto expanding the teaching material.

Learning material expanding systems and teaching material auto expanding methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the disclosure has been described by way of example and in terms of exemplary embodiment, it is to be understood that the invention is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A teaching material auto expanding method for expending an input teaching material data comprising at least one sentence unit into a database in a learning material expanding system, wherein the database has at least one subject and a structure information corresponding thereto, each subject having a corresponding subject category and each subject category having at least one corresponding subject sentence unit, the method comprising:
calculating a subject similarity value corresponding to the subject in the database for the sentence unit in the input teaching material data, wherein the subject similarity value comprises a content similarity value and a structure similarity value corresponding to the subject;
performing a confidence measurement operation to obtain a confidence measurement value of the subject by using the subject similarity value for the sentence unit; and
determining an expanding manner for the sentence unit based on the obtained confidence measurement value corresponding thereto.

2. The teaching material auto expanding method of claim 1, wherein the determining step further comprises:
determining the expanding manner for the sentence unit as to add a subject category when the confidence measurement value of the sentence unit is less than a reject threshold.

3. The teaching material auto expanding method of claim 2, further comprising:
determining whether the confidence measurement value of the sentence unit exceeds an accept threshold when the confidence measurement value of the sentence unit exceeds the reject threshold; and
when the confidence measurement value of the sentence unit exceeds the accept threshold, determining the expanding manner for the sentence unit as to merge the sentence unit into a corresponding one of the subject categories automatically.

4. The teaching material auto expanding method of claim 3, further comprising:
when the confidence measurement value of the sentence unit is less than or equal to the accept threshold, determining the expanding manner for the sentence unit as to automatically display candidate subjects ordered by the corresponding subject similarity values in sequence and display at least one recommended subject.

5. The teaching material auto expanding method of claim 1, wherein the calculating step further comprises:
obtaining at least one candidate subject corresponding to the sentence unit among the subjects in the database according to the content similarity value of the sentence unit; and
obtaining the structure similarity value of the sentence unit corresponding to the subject according to a corresponding structural relationship between the candidate subject and the structure information.

6. The teaching material auto expanding method of claim 5, further comprising:
providing a weighting value; and
determining a ratio of the content similarity value and the structure similarity value of the sentence unit corresponding to the subject according to the weighting value to obtain the subject similarity value corresponding to the subject for the sentence unit.

7. The teaching material auto expanding method of claim 1, further comprising:
for the sentence unit, obtaining semantic similarity values between the sentence unit and the subject sentence unit of the subject and utilizing the semantic similarity values corresponding to the subject to obtain the content similarity value corresponding to the subject.

8. The teaching material auto expanding method of claim 7, wherein utilizing the semantic similarity values corresponding to the subject to obtain the content similarity value corresponding to the subject is performed by configuring a maximum semantic similarity value among the semantic similarity values as the content similarity value corresponding to the subject.

9. The teaching material auto expanding method of claim 8, wherein the semantic similarity values between the sentence unit and the subject sentence unit of the subject is obtained by performing at least a tokenization, a stop words filtering, a part-of-speech tagging, a keyword extraction and a keyword weighting adjustment steps.

10. A learning material expanding system, comprising:
a database, having a plurality of subjects and at least one structure information corresponding thereto, wherein each of the subjects has a corresponding subject category and each subject category has at least one corresponding subject sentence unit;
a content similarity calculation module coupled to the database, receiving an input teaching material data comprising a plurality of sentence units and calculating subject similarity values corresponding to all of the subjects in the database, each of which corresponding to one of the subjects, for each of the sentence units in the input teaching material data, wherein the sentence units of the input teaching material data has a flow structure information;
a structure similarity calculation module coupled to the content similarity calculation module, utilizing the flow structure information and the structure information of the database to obtain structure similarity values corresponding to the subjects, each of which corresponding to one of the subjects, for each of the sentence units;
a subject similarity calculation module coupled to the content similarity calculation module and the structure similarity calculation module, obtaining subject similarity values corresponding to the subjects, each of which corresponding to one of the subjects, according to the corresponding content similarity value and the corresponding structure similarity value of each of the subjects for each of the sentence units;
a confidence calculation module coupled to the subject similarity calculation module, performing a confidence measurement operation to obtain a confidence measurement value of each of the subjects by using the subject similarity value of each of the subjects for each of the sentence units; and
an auto expanding module coupled to the confidence calculation module, determining an expanding manner for each of the sentence units based on the obtained confidence measurement value corresponding thereto so as to adding the input teaching material data into the database.

11. The learning material expanding system of claim 10, wherein the auto expanding module further determines the expanding manner for one of the sentence units as to add a subject category when the confidence measurement value of the sentence unit is less than a reject threshold.

12. The learning material expanding system of claim 11, wherein the confidence calculation module further determines whether the confidence measurement value of the sentence unit exceeds an accept threshold when the confidence measurement value of the sentence unit exceeds or equals to the reject threshold and after determines that the confidence measurement value of the sentence unit exceeds the accept threshold, determines the expanding manner for the sentence unit as to automatically merge the sentence unit into a corresponding one of the subject categories.

13. The learning material expanding system of claim 12, further comprising a display unit, and wherein when the confidence measurement value of the sentence unit is less than or equal to the accept threshold, the auto expanding module further determines the expanding manner for the sentence unit as to automatically display candidate subjects ordered by the corresponding subject similarity values in sequence and display at least one recommended subject on the display unit.

14. The learning material expanding system of claim 10, wherein the content similarity calculation module further obtains at least one candidate subject of each of the sentence units corresponding to each of the subjects according to the content similarity value of each of the sentence units, and the structure similarity calculation module further obtains the structure similarity value of each of the sentence units corresponding to each of the subjects according to a corresponding structural relationship between the candidate subjects of each of the sentence units and the structure information.

15. The learning material expanding system of claim 14, wherein the subject similarity calculation module further determines a ratio of the content similarity value and the structure similarity value of each sentence unit corresponding to each subject according to a weighting value to obtain the subject similarity value of each sentence unit corresponding to each subject.

16. The learning material expanding system of claim 10, wherein the content similarity calculation module further obtains a semantic similarity value for the sentence unit and the sentence unit of each subject for each sentence unit, and utilizes the semantic similarity value corresponding to each subject to obtain the content similarity value corresponding to each subject.

17. The learning material expanding system of claim 16, wherein the content similarity calculation module further configures a maximum semantic similarity value among the semantic similarity values corresponding to each subject as the content similarity value of each subject.

18. A machine-readable storage medium comprising a computer program, which, when executed, causes an apparatus to perform a teaching material auto expanding method for expending an input teaching material data comprising at least one unit into a database in a learning material expanding system, wherein the database has a plurality of subjects and a structure information corresponding thereto, each subject having a corresponding subject category and each subject category having at least one corresponding subject sentence unit, the method comprising:
calculating subject similarity values corresponding to the subjects in the database, each of which corresponding to one of the subjects, for each of the sentence units in the input teaching material data, wherein each subject similarity value comprises a content similarity value and a structure similarity value corresponding to one of the subjects;
performing a confidence measurement operation to obtain a confidence measurement value of each subject by using the corresponding subject similarity value of each subject for each sentence unit; and
determining an expanding manner for the sentence unit based on the obtained confidence measurement values corresponding thereto,
wherein the expanding manner comprises adding a subject category, automatically merging the sentence unit into a corresponding one of the subject categories, and automatically displaying candidate subjects ordered by the corresponding subject similarity values in sequence and displaying at least one recommended subject.

19. The machine-readable storage medium of claim 18, wherein the determining step further comprises:
for each sentence unit, obtaining a semantic similarity value between the sentence unit and the subjects sentence units of each subject and utilizing the semantic similarity values corresponding to each subject to obtain the content similarity value corresponding to each subject.

20. The machine-readable storage medium of claim 19, wherein the method further comprises:
obtaining at least one candidate subject of each sentence unit corresponding to each subject according to the content similarity value of each sentence unit; and
obtaining the structure similarity value of each sentence unit corresponding to each subject according to a corresponding structural relationship between the candidate subjects corresponding to the sentence unit and the structure information.
